(19) United States
(12) Patent Application Publication
(10) Pub. No.: US 2011/0284321 A1
(43) Pub. Date: Nov. 24, 2011

(54) ADJUSTABLE HARNESS LEG LOOP

(76) Inventors: Jacob Hall, Draper, UT (US); Peater Karl Wilkening, (US)

(21) Appl. No.: 12/784,052

(22) Filed: May 20, 2010

(51) Int. Cl. A62B 35/00

(52) U.S. Cl. 182/3

(57) ABSTRACT

The present invention relates to adjustable harness leg loops. One embodiment of the present invention relates to a harness leg loop system comprising a first and second leg loop intercoupled with one another at respective coupling points. The first and second leg loops include interior regions within which a user's leg may be disposed. The areas of the interior regions are individually selectively adjustable via respective slidable members disposed between the interior region and the coupling point of each leg loop. The selective adjustability of the interior region areas does not substantially affect the rise between the interior regions and the coupling points. The minimum shear strength of the interior regions is independent of the slidable members. Therefore, if one of the slidable members fails, an object coupled through the interior region will not necessarily break free from the interior region.

### FIELD OF THE INVENTION

The invention generally relates to harness leg loops. In particular, the present invention relates to an improved system for adjustable harness leg loops.

### BACKGROUND OF THE INVENTION

A harness is used to physically support a user from an anchor via some form of attachment. For example, a user may be supported in a harness while descending (i.e. abseiling/rappelling) a rope via a slidable intercoupling between the harness and the rope. The slidable intercoupling may be facilitated by a mechanical device that allows the user to control the relative descent of the harness with respect to the rope. A harness may also be used to support a user in a fixed location with respect to an anchor for an extended period of time.

Various types of harnesses are used based on desired performance characteristics corresponding to a particular activity. These characteristics include weight, adjustment range, usability, safety, strength, etc. Most rock climbing and rappelling type harnesses include a waist belt and a set of leg loops interconnected at a frontal location. The waist belt is generally adjustable and/or releasable to enable a user to engage and subsequently cinch the waist belt around the naval region. Various types of adjustment mechanisms are used on the waist belt to permit adjustability while maintaining sufficient strength. The leg loops are designed to encircle each of the user's legs, respectively. In order to accommodate variations in user leg circumferences, many harnesses include some form of adjustment mechanism on each of leg loops.

Existing adjustable leg loop systems suffer from one or more distinct problems. First, existing adjustable leg loops often significantly increase the weight of the overall harness by utilizing heavy adjustable buckles that are designed to be a structural component in the load bearing capacity of the leg loop. Second, existing adjustable leg loops may only permit a very narrow and/or imprecise adjustment range as a result of some form elastic member disposed within the leg loop. Third, existing adjustable leg loops may be overly complex and/or increase the risk of user error. Fourth, existing adjustable leg loops may include loose materials that extend away from an adjustment buckle (i.e. a tail of webbing). Loose material is undesirable both aesthetically for the disorganized appearance and functionally for the potential of snagging or tangling with other equipment and/or environmental objects.

Therefore, there is a need in the industry for an adjustable harness leg loop system that maintains required strength tolerances while overcoming the problems described above.

### SUMMARY OF THE INVENTION

The present invention relates to adjustable harness leg loops. One embodiment of the present invention relates to a harness leg loop system comprising a first and second leg loop intercoupled with one another at respective coupling points. The first and second leg loops include interior regions within which a user's leg may be disposed. The areas of the interior regions are individually selectively adjustable via respective slidable members disposed between the interior region and the coupling point of each leg loop. The selective adjustability of the interior region areas does not substantially affect the rise between the interior regions and the coupling points. The minimum shear strength of the interior regions is independent of the slidable members. Therefore, if one of the slidable members fails, an object coupled through the interior region will not necessarily break free from the interior region. Alternative embodiments of the present invention may include disposing one or more slidable friction members on the leg loop, so as to operate in conjunction with the slidable member and facilitate the individual selective adjustment. A further alternative embodiment relates to a method for adjusting the area of an interior region within a harness adjustable leg loop system, comprising providing an adjustable leg loop including translating a slidable member with respect to the coupling point and adjusting the area of the interior region substantially independent of the rise between the interior region and the coupling point.

Embodiments of the present invention represent a significant advance in the field of harness construction. The selective adjustability system of the slidable members enables the respective leg loop to adjust the area within which a user's leg is disposed without substantially affecting the rise. The area may also be adjusted over a relatively large range to accommodate a wide variety of leg dimensions. Likewise, the slidable members are not structural components with respect to the minimum shear strength of the interior regions and therefore may be composed of lightweight materials. Further, the selective adjustability does not necessarily include any form of extraneous materials.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The following description of the invention can be understood in light of the Figures, which illustrate specific aspects of the invention and are a part of the specification. Together with the following description, the Figures demonstrate and explain the principles of the invention. In the Figures, the physical dimensions may be exaggerated for clarity. The same reference numerals in different drawings represent the same element, and thus their descriptions will be omitted.

FIG. 1 illustrates a perspective view of a single harness leg loop in accordance with a first embodiment of the present invention;

FIG. 2 illustrates a perspective view of a single harness leg loop in accordance with a second embodiment of the present invention;

FIG. 3 illustrates a perspective view of a single harness leg loop in accordance with a third embodiment of the present invention;

FIG. 4 illustrates a complete harness system incorporating two leg loops in accordance with embodiments of the present invention;

FIG. 5 illustrates a perspective view of a single harness leg loop in accordance with a fourth embodiment of the present invention;

FIG. 6 illustrates a perspective view of a single harness leg loop in accordance with a fourth embodiment of the present invention;

FIG. 7 illustrates a perspective view of a single harness leg loop in accordance with a fourth embodiment of the present invention; and

FIG. 8 illustrates a perspective view of a single harness leg loop in accordance with a fourth embodiment of the present invention.

### DETAILED DESCRIPTION OF THE INVENTION

The present invention relates to adjustable harness leg loops. One embodiment of the present invention relates to a harness leg loop system comprising a first and second leg loop intercoupled with one another at respective coupling points. The first and second leg loops include interior regions within which a user's leg may be disposed. The areas of the interior regions are individually selectively adjustable via respective slidable members disposed between the interior region and the coupling point of each leg loop. The selective adjustability of the interior region areas does not substantially affect the rise between the interior regions and the coupling points. The minimum shear strength of the interior regions is independent of the slidable members. Therefore, if one of the slidable members fails, an object coupled through the interior region will not necessarily break free from the interior region. Alternative embodiments of the present invention may include disposing one or more slidable friction members on the leg loop, so as to operate in conjunction with the slidable member and facilitate the individual selective adjustment. A further alternative embodiment relates to a method for adjusting the area of an interior region within a harness adjustable leg loop system, comprising providing an adjustable leg loop including translating a slidable member with respect to the coupling point and adjusting the area of the interior region substantially independent of the rise between the interior region and the coupling point. Also, while embodiments are described in reference to a harness leg loop adjustment system, it will be appreciated that the teachings of the present invention are application to other areas.

The following terms are defined as follows:

### DEFINITIONS

Tri-glide buckle member—a particular buckle design configuration which includes two independent recesses.

Slidable member—a member configured to slide or translate with respect to another member. An example of a slidable member is a buckle which may be translated to various locations along an elongated member.

Slidable friction member—a particular type of slidable member that further includes engaging a frictional force in at least one orientation of translation.

Minimum shear strength—the minimum shear force at which a particular contained member breaks free. For example, if a member is contained within a loop formed by an elongated member having varying degrees of thickness, the minimum shear strength at which the contained member will break free of the loop is assumed to be the shear strength at the narrowest/weakest region of the loop.

Harness leg loop coupling point—a location on a harness leg loop at which the leg loop is coupled with the other leg loop and the remainder of the harness. For purposes of this application, this will be referred to as the coupling point for a particular leg loop.

Harness leg loop interior region—an interior region of a leg loop formed by a loop of an elongated member. For purposes of this application, this will be referred to as the interior region for a particular leg loop.

Rise—A measurement of the distance between a harness leg loop coupling point and the interior region.

Translatable buckle members—a type of slidable member that includes a buckle which may be translated along one or more elongated members.

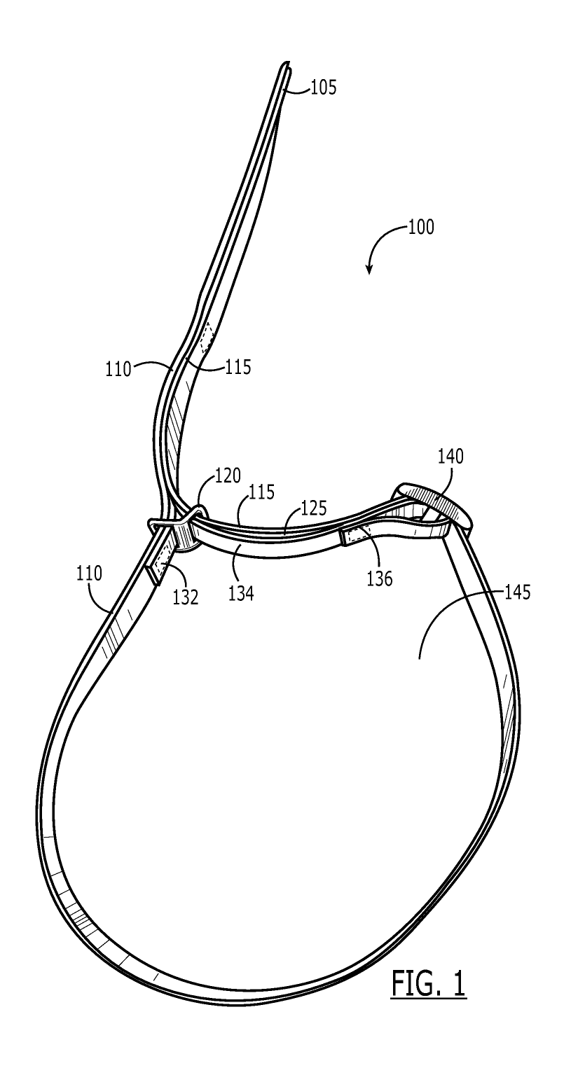

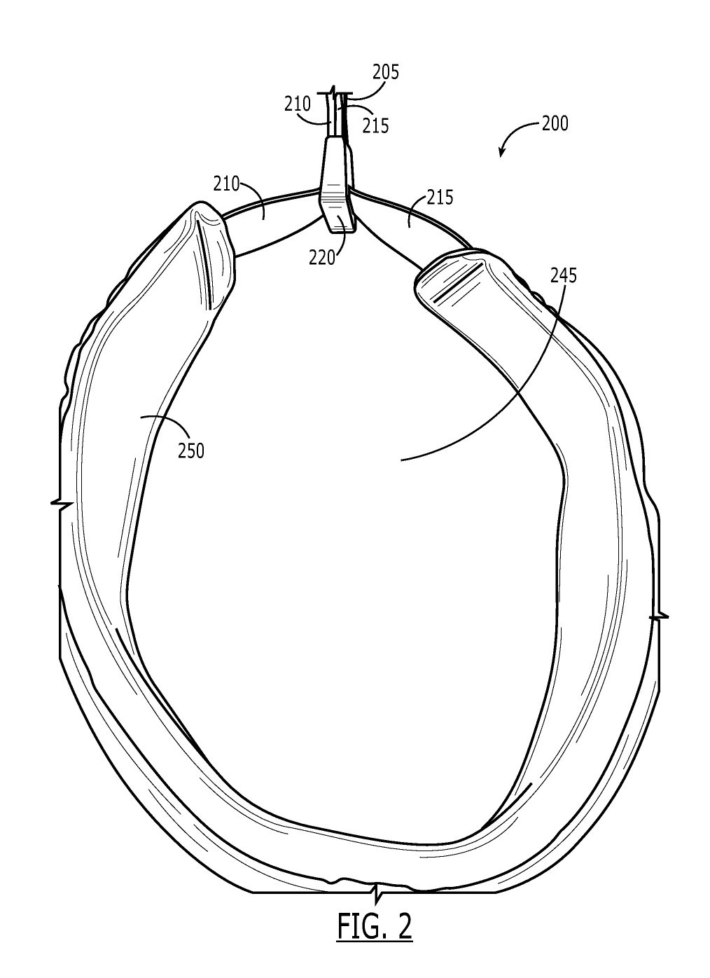

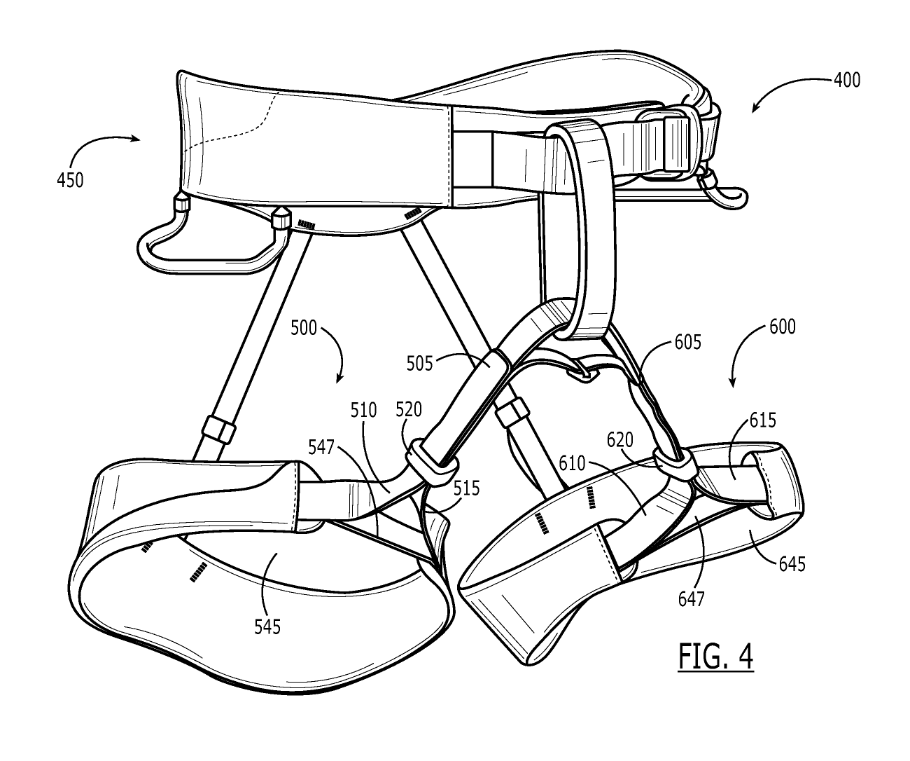

Reference is initially made to FIG. 1, which illustrates a perspective view of a single harness leg loop in accordance with a first embodiment of the present invention, designated generally at 100. The system 100 includes an elongated member with two ends that form a loop. The elongated member may be composed of nylon webbing or other similar material. The two ends of the elongated member are disposed at a coupling point 105. In particular, the loop of the elongated member includes a left and right region 110, 115 encircling an interior region 145. A slidable member 120 is independently slidably coupled to a portion of the left and right regions 110, 115 respectively. The slidable member is a translatable buckle member and may particularly be a tri-glide type buckle including two recesses and composed of a lightweight material such as plastic. Alternative slidable member and translatable buckle member configurations are described below in reference to FIG. 2-8. The slidable member 120 is positioned between the interior region 145 and the coupling point 105. An optional slidable friction member 140 is slidably coupled to the right region 115 of the elongated member. The slidable friction member may also be a tri-glide type buckle including two recesses, and it may be composed of a lightweight material such as plastic. In the illustrated embodiment, a secondary loop 125 is formed by a second elongated member 134 coupling to the left region 110 at a left coupling point 132. The secondary elongated member 134 is slidable coupled through the slidable member 120. The secondary elongated member 134 is also coupled to the slidable friction member 140 via a loop coupling 136. Therefore, the area of the interior region 145 is defined by the relative location of the slidable member 120 and the slidable friction member 140 with respect to the elongated member. The ends of the elongated member may be coupled at the coupling point 105 via one or more mechanical stitching and/or chemical bonding systems. The coupling point 105 is configured to be coupled to a second leg loop and a waist belt (see FIG. 4).

The leg loop system 100 has a particular minimum shear strength at which the system 100 fails to retain an object coupled within the interior region 145 with respect to the coupling point 105. The minimum shear strength is determined by the weakest portion of the system 100 which forms a structural component of the loop and/or interior region 145. The elongated member forms a continuous loop around the interior region 145 and is therefore the only structural component. Therefore, the slidable member 120 and the slidable friction member 140 are not structural components that affect the minimum shear strength of the interior region 145 with respect to the coupling point 105. For example, if both the slidable member 120 and the slidable friction member 140 fail/break, the interior region 145 will not necessarily sever because the shear strength of the elongated member is stronger than the slidable member 120 and the slidable friction member 140. In the event that the slidable member 120 and the slidable friction member 140 fail, the area of the interior region 145 may expand, but the continuous loop of the elongated member will remain.

In operation, the slidable member 120 and the slidable friction member 140 may be selectively adjusted to alter the area of the interior region 145. In the illustrated embodiment, a user may translate the slidable friction member 140 along the right side 115 of the elongated member with respect to the slidable member 120. The area of the interior region 145 is increased in an amount corresponding to the distance at which the slidable friction member 140 is translated toward the slidable member 120. As the slidable friction member 140 is translated toward the slidable member 120, the second elongated member 134 translates through the slidable member 120 and allows the left region 110 of the elongated member to extend from the slidable member 120. It will be noted that various lengths of second elongated members 134 may be utilized so as to adjust the adjustability range and the tactile resistance of the slidable friction member 104 with respect to the elongated member. It will also be noted that the rise between the interior region 145 and the coupling point 105 is not substantially affected by the relative adjustment of the slidable member 120 or the slidable friction member 140. The coupling configuration of the slidable member 120 automatically substantially maintains the interior region 145 rise while the area of the interior region 145 is adjusted.

Reference is next made to FIG. 2, which illustrates a perspective view of a single harness leg loop in accordance with a second embodiment of the present invention, designated generally at 200. The system 200 includes an elongated member forming a loop. A coupling point 205 is formed by the two ends of the elongated member. An interior region 245 is defined by the loop of the elongated member. In particular, a left and right region 210, 215 of the elongated member encircle the interior region 245. A slidable member 220 is independently slidably coupled to the left and right regions 210, 215 between the interior region 245 and the coupling point 205. As discussed above, the elongated member forms a continuous loop around the interior region 245, and therefore the slidable member 220 is not a structural component with respect to the minimum shear strength of the interior region 245. In operation, the area of the interior region 245 may be increased by translating the slidable member 220 toward the coupling point 205 thereby allowing additional portions of the left and right region 210, 215 to form the interior region 245. As discussed above, the configuration of the slidable member 220 enables the rise between the interior region 245 and the coupling point 205 to be substantially independent of the area adjustment of the interior region 245. An optional padding member 250 is coupled to the interior surface of the left and right regions 210, 215 forming the interior region 245. The padding member 250 is not a structural component of the system 200 and is configured to cushion the support of a user's leg to minimize chaffing and/or irritability.

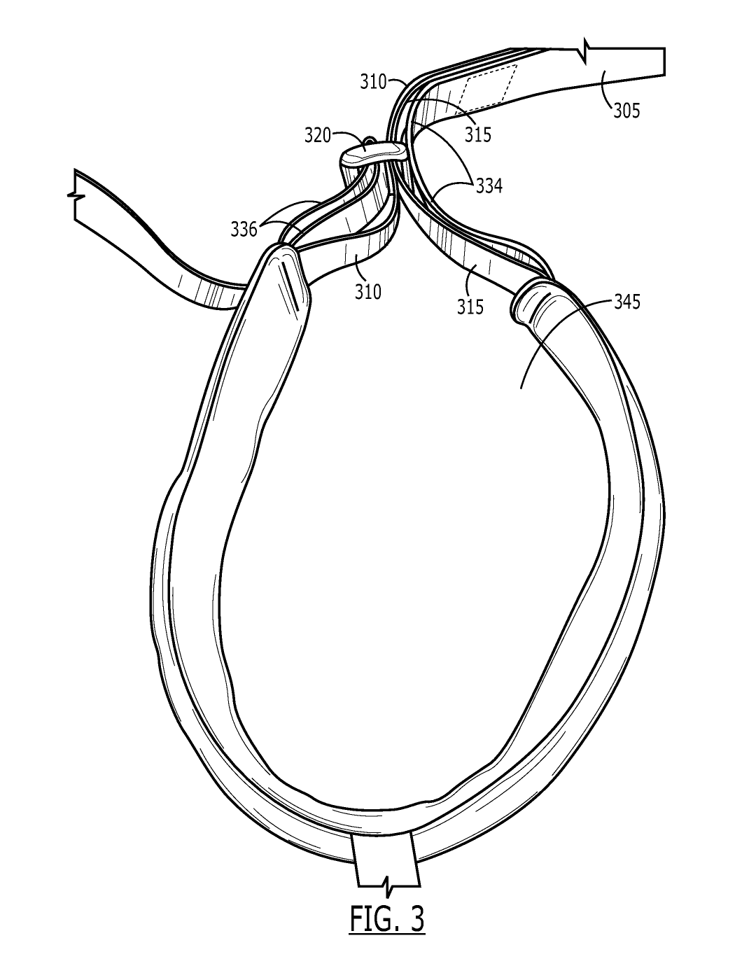

Reference is next made to FIG. 3, which illustrates a perspective view of a single harness leg loop in accordance with a third embodiment of the present invention, designated generally at 300. The system includes an elongated member that forms a loop. A coupling point 305 is formed by the two ends of the elongated member. An interior region 345 is defined by the loop of the elongated member. In particular, a left and right region 310, 315 of the elongated member encircle the interior region 345. A slidable member 320 is independently slidably coupled to the left and right regions 310, 315 between the interior region 345 and the coupling point 305. The elongated member further includes a second left region 336 and a second right region 334. The second left and right regions 336, 334 are disposed on the outer sides of the left and right regions 310, 315 respectively. Therefore, the second left region 336 is disposed further left of the left region 310 and the second right region 334 is disposed further right of the right region 310. The second right region 334 is coupled to the coupling point 305 and extends around a portion of the interior region 345. The second left region 336 is not coupled to the coupling point 305 but does extend around a portion of the interior region 345. The second left region 336 is also slidably coupled through the slidable member 320. The slidable member includes two recesses, one of which includes the left region 310, right region 315, and the second left region 336. The second left region 336 is then folded back through the second recess of the slidable member 320. In operation, the slidable member 320 translated toward the coupling point 305 so as to increase the area of the interior region 345. The second left region 336 may add additional friction to the relative position of the slidable member 320 with respect to the left and right region 310, 315 so as to prevent inadvertent adjustment due to slippage. As discussed above, the configuration of the slidable member 320 enables the rise between the interior region 345 and the coupling point 305 to be substantially independent of the area adjustment of the interior region 345. An optional padding member 350 is coupled to the interior surface of the left and right regions 310, 315 forming the interior region 345. The padding member 350 is not a structural component of the system 300 and is configured to cushion and support a user's leg to minimize chaffing and/or irritability.

Reference is next made to FIG. 4, which illustrates a complete harness system incorporating two leg loops in accordance with embodiments of the present invention, designated generally at 400. The system 400 includes an adjustable waist belt 450, a left leg loop system 500, and a right leg loop system 600. The left and right leg loop systems 500, 600 incorporate an adjustment system embodiment similar to FIG. 2. Therefore, a more detailed description of the operation of the illustrated adjustment system is discussed above with reference to FIG. 2. The left and right leg loop systems 500, 600 each include a coupling point 505, 605, a slidable member 520, 620, and an interior region 545, 645. The slidable members 520, 620 are both coupled around respective left regions 510, 610 and right regions 515, 615 of the respective elongated members forming the leg loops. An optional elastic adjustment member 547, 647 is extended between the respective left regions 510, 610 and right regions 515, 615 of the respective elongated members. The elastic adjustment members 547, 647 are configured for increased user comfort. The coupling points 505, 605 are intercoupled at a frontal location through a loop that is coupled to the adjustable waist belt 450. Therefore, the harness exhibits redundancy of strength and/or reliability between the waist belt, the left leg loop, and the right leg loop. In the event of a system failure, a user may theoretically be supported by any one or more features of the waist belt, the left leg loop, and the right leg loop.

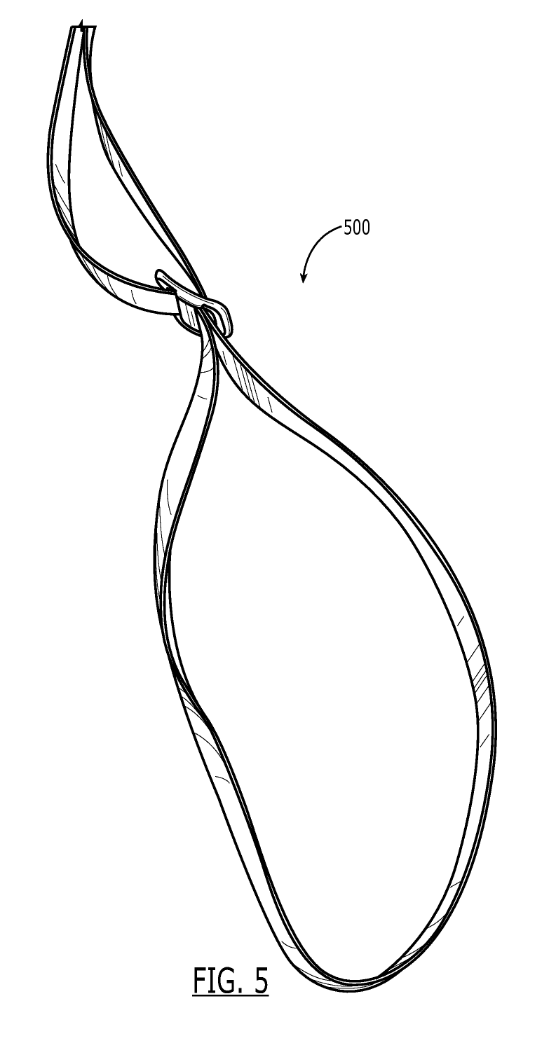

Reference is next made to FIG. 5, which illustrates a single harness leg loop in accordance with embodiments of the present invention, designated generally at 500. The system 500 includes an elongated member with two ends that form a loop. The elongated member may be composed of nylon webbing or other similar material. The two ends of the elongated member are disposed at a coupling point. In particular, the loop of the elongated member includes a left and right region encircling an interior region. A slidable member is independently slidably coupled to a portion of the left and right regions, respectively. The slidable member may be a tri-glide type buckle including two recesses and composed of a lightweight material such as plastic. The slidable member is positioned between the interior region and the coupling point. The left and right regions are routed through the slidable member. In the illustrated embodiment, a secondary loop is formed between the slidable member and the coupling point. The ends of the elongated member may be coupled at the coupling point via one or more mechanical stitching and/or chemical bonding systems. The coupling point is configured to be coupled to and/or integrated with a second leg loop and a waist belt (see FIG. 4). In operation, the slidable member may be selectively adjusted/translated to alter the area of the interior region without substantially affecting the rise between the interior region and the coupling point.

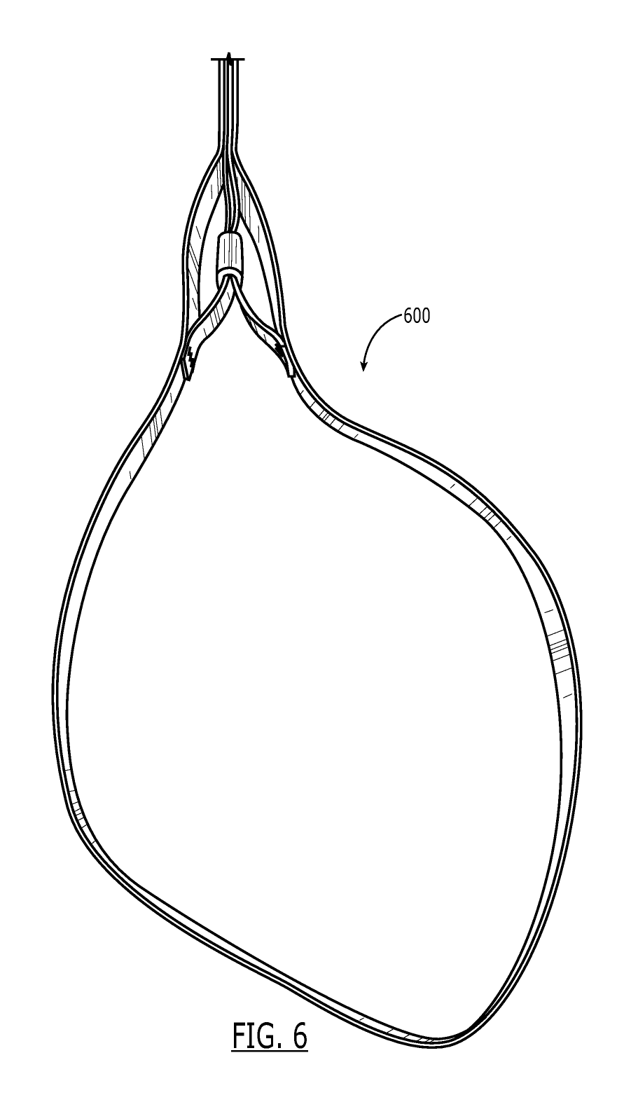

Reference is next made to FIG. 6, which illustrates a single harness leg loop in accordance with embodiments of the present invention, designated generally at 600. The system 600 includes an elongated member with two ends that form a loop. The elongated member may be composed of nylon webbing or other similar material. The two ends of the elongated member are disposed at a coupling point. In particular, the loop of the elongated member includes a left and right region encircling an interior region. A secondary left and right elongated member are intercoupled between respective portions of the left and right region of the elongated member. The secondary left and right elongated members may be composed of an elastic material. A slidable member is independently slidably coupled to a portion of the secondary left and right elongated members, respectively. The slidable member may be a single recess type cylindrical buckle including composed of a lightweight material such as rubber or plastic. The slidable member is positioned between the interior region and the coupling point. The secondary left and right elongated members are routed through the slidable member. In the illustrated embodiment, a secondary loop is formed between the slidable member and the coupling point. The coupling point is configured to be coupled to and/or integrated with a second leg loop and a waist belt (see FIG. 4). In operation, the slidable member may be selectively adjusted/translated to alter the area of the interior region without substantially affecting the rise between the interior region and the coupling point.

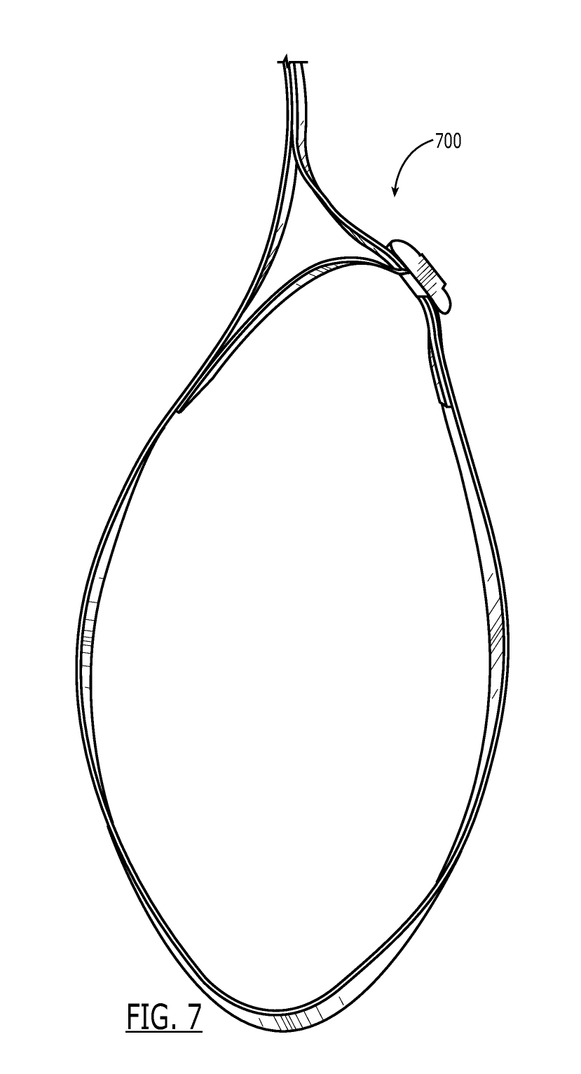

Reference is next made to FIG. 7, which illustrates a single harness leg loop in accordance with embodiments of the present invention, designated generally at 700. The system 700 includes an elongated member with two ends that form a loop. The elongated member may be composed of nylon webbing or other similar material. The two ends of the elongated member are disposed at a coupling point. In particular, the loop of the elongated member includes a left and right region encircling an interior region. A slidable member is independently slidably coupled to a portion of the right region. The slidable member may be a tri-glide type buckle including two recesses. The slidable member may be composed of a lightweight material such as plastic. A secondary elongated member is coupled to the left region and the slidable member. The slidable member is positioned between the interior region and the coupling point. In the illustrated embodiment, a secondary loop of the elongated member is formed between the slidable member, the secondary elongated member, and the coupling point. The coupling point is configured to be coupled to and/or integrated with a second leg loop and a waist belt (see FIG. 4). In operation, the slidable member may be selectively adjusted/translated along the right region to alter the area of the interior region without substantially affecting the rise between the interior region and the coupling point.

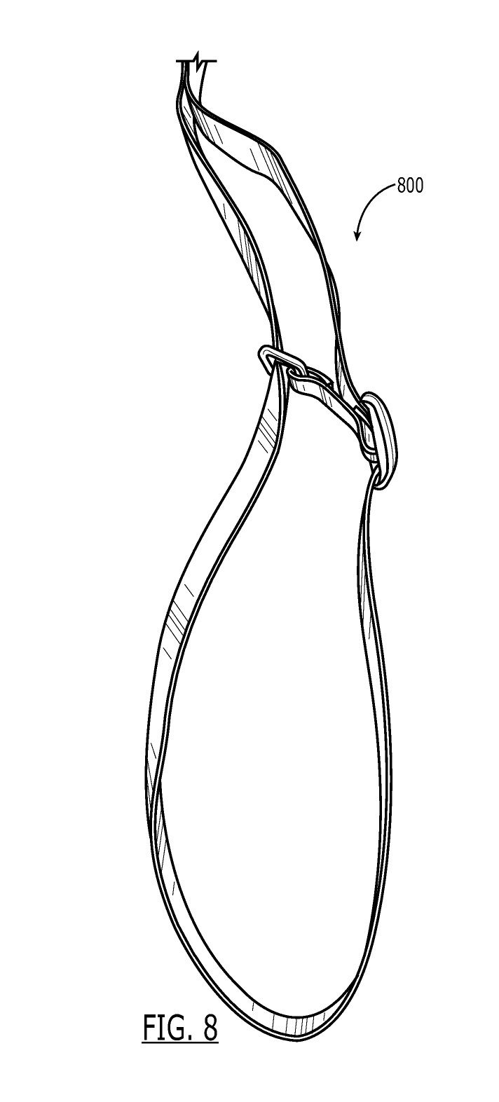

Reference is next made to FIG. 8, which illustrates a single harness leg loop in accordance with embodiments of the present invention, designated generally at 800. The system 800 includes an elongated member with two ends that form a loop. The elongated member may be composed of nylon webbing or other similar material. The two ends of the elongated member are disposed at a coupling point. In particular, the loop of the elongated member includes a left and right region encircling an interior region. A slidable member is independently slidably coupled to a portion of the right region. The slidable member may be a tri-glide type buckle including two recesses. The slidable member may be composed of a lightweight material such as plastic. A secondary elongated member is slidably coupled to the left region and coupled to the slidable member. The slidable member is positioned between the interior region and the coupling point. In the illustrated embodiment, a secondary loop of the elongated member is formed between the slidable member, the secondary elongated member, and the coupling point. The coupling point is configured to be coupled to and/or integrated with a second leg loop and a waist belt (see FIG. 4). In operation, the slidable member may be selectively adjusted/translated along the right region to alter the area of the interior region without substantially affecting the rise between the interior region and the coupling point.

It should be noted that various alternative system designs may be practiced in accordance with the present invention, including one or more portions or concepts of the embodiment illustrated in FIG. 1 or described above. Various other embodiments have been contemplated, including combinations in whole or in part of the embodiments described above.

What is claimed is:

1. A harness leg loop system comprising:
a first leg loop including a first interior region and a first coupling point;
a second leg loop including a second interior region and a second coupling point, wherein the first and second coupling points are intercoupled, and wherein the first and second leg loop include a particular minimum shear strength of the first and second interior regions with respect to the coupling point;
wherein the area of the first and second interior regions are individually selectively adjustable via a first and second slidable member intercoupled with the first and second leg loop respectively, wherein the first and second slidable members are translatable buckle members; and
wherein the particular minimum shear strength of the first and second leg loop is independent of the first and second slidable member and the area of the first and second interior region.

2. The system of claim 1, wherein the first and second slidable members are disposed between each of the first and second interior regions and the first and second coupling point respectively.

3. The system of claim 1, wherein the first and second slidable members are configured to selectively translate toward the first and second coupling point thereby increasing the area of the first and second interior region in response to a user trigger motion.

4. The system of claim 1, wherein the minimum shear strength of the first and second interior regions is the minimum force at which a member coupled through one of the first and second interior regions will disengage from the respective first and second interior region as a result of a shear force.

5. The system of claim 1, wherein the area of the first and second interior region are further individually selectively adjustable via a first and second slidable friction member intercoupled with the first and second leg loop respectively, and wherein the particular minimum shear strength of the first and second leg loop is independent of the first and second slidable friction member.

6. The system of claim 5, wherein the first and second slidable friction member are oriented substantially parallel to the first and second leg loop respectively.

7. The system of claim 5, wherein the first and second slidable friction member are separated from the first and second slidable member.

8. The system of claim 5, wherein the first and second slidable friction member are directly adjacent to the first and second slidable member.

9. The system of claim 5, wherein the first and second slidable friction member are tri-glide type buckle members.

10. The system of claim 1, wherein the first and second slidable member are tri-glide type buckle members.

11. The system of claim 1, wherein the first and second leg loop further include a first and second elongated member respectively, and wherein the first and second elongated members each include two ends disposed at the coupling point and forming a continuous loop therebetween, and wherein the first and second slidable member are coupled to two independent regions on the first and second elongated member respectively.

12. The system of claim 1, wherein the particular minimum shear strength of the first and second leg loop is dependent only upon the shear strength of the first and second elongated member forming the first and second leg loop and the respective intercouplings therebetween.

13. The system of claim 1, wherein the selective adjustability of the first and second interior regions is substantially independent of the rise between the first and second interior region and the first and second coupling point respectively.

14. A harness leg loop system comprising:
a first leg loop including a first interior region and a first coupling point;
a second leg loop including a second interior region and a second coupling point, wherein the first and second coupling points are intercoupled, and wherein the first and second leg loop include a particular minimum shear strength of the first and second interior regions with respect to the coupling point;
wherein the area of the first and second interior regions are individually selectively adjustable via a first and second slidable member intercoupled with the first and second leg loop respectively; and
wherein the first and second leg loop further include a first and second elongated member respectively, and wherein the first and second elongated members each include two ends disposed at the coupling point and forming a continuous loop therebetween, and wherein the first and second slidable member are coupled to two independent regions on the first and second elongated member respectively, and wherein the first and second slidable members are translatable buckle members.

15. A method for adjusting the area of an interior region within a harness adjustable leg loop system comprising the acts of/comprising:
providing an adjustable leg loop including an interior region, an elongated member, and a coupling point, wherein the interior region is a region within a loop of the elongated member;
providing a slidable member disposed on the adjustable leg loop between the interior region and the coupling point, wherein the slidable member is a translatable buckle member;
translating the slidable member with respect to the coupling point; and
adjusting the area of the interior region substantially independent of the rise between the interior region and the coupling point;

16. The method of claim 15, wherein the act of translating the slidable member with respect to the coupling point includes translating over two portions of the elongated member.

17. The method of claim 15, wherein the act of translating the slidable member with respect to the coupling point includes translating a tri-glide buckle over two opposite portions of the elongated member with respect to the ends of the elongated member.

18. The method of claim 15, wherein the act of adjusting the area of the interior region substantially independent of the rise between the interior region and the coupling point includes increasing the area of the interior region in response to translating the slidable member toward the coupling point and decreasing the area of the interior region in response to translating the slidable member away from the coupling point.

19. The method of claim 15, wherein the act of adjusting the area of the interior region substantially independent of the rise between the interior region and the coupling point includes translating a slidable friction member within a secondary loop on the elongated member with respect to the slidable member.

20. The method of claim 19, wherein the act of adjusting the area of the interior region substantially independent of the rise between the interior region and the coupling point further includes adjusting the orientation of the secondary loop with respect to the slidable member and the interior region.
